(19) United States
(12) Patent Application Publication
(10) Pub. No.: US 2007/0247317 A1
(43) Pub. Date: Oct. 25, 2007

(54) Apparatus and method for fine art authentication

(76) Inventor: Rick Farrell, Lake Forest, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/408,575

(22) Filed: Apr. 21, 2006

(51) Int. Cl. G08B 13/14; G05B 19/00

(52) U.S. Cl. 340/572.8; 340/572.3; 340/5.8

(57) ABSTRACT

The present invention incorporates a fine art authentication system to authenticate artwork that are certified to be originals from an accounted-for limited edition. Each reproduction has a non-reproducible RFID (Radio Frequency Identification Device) tag attached to the back of the canvas or paper, using a specially developed inert compound that will not react with the canvas or inks. The bonding is secure, acid-free and will not hurt or degrade the image. The embedded RFID tag is covered with a Lexan disk identifying the art as an authentic original reproduction. The RFID tag contains an electronic serial number that can be read by an inexpensive RFID scanner at participating galleries. This number is unique to the artist, the image and the edition number and cannot be duplicated. The device cannot be removed without damaging artwork and rendering the RFID tag inoperative. The electronically encrypted data may include the serial number, date of purchase, name of artist and number of reprints in the limited edition. The process allows certification that the artwork is authentic and that it is a specific number from the limited edition.

### BACKGROUND OF THE INVENTION

1. Field of the Invention

The present invention uses RFID technology to provide a fine art authentication system. Such authentication will impact the art world by eliminating forgeries, deterring theft, aiding insurance identification and increasing fine art buyer confidence. The inventive technology will benefit artists, fine art galleries and fine art buyers. It will enable artists to authenticate and secure their unique creative works, substantiate edition runs and eliminate forgeries of their art from entering the market. It will allow galleries to increase buyer confidence, reduce insurance premiums, register buyers and add value to artwork. It will enable collectors to qualify their investment decisions, verify insurance coverage and increase the resale value of artwork. With the present invention, art collectors can now be certain that the artwork they purchase is authentic.

2. Background Art

The present ink jet technology used to produce fine art reproductions provides numerous benefits over the previous lithographic processes. Advances have been made in resolution, color gamut and image longevity, in addition to other technical advantages. The greater efficiency and lower cost to produce small quantities of reproductions are also of great advantage to the newly published artist.

The recent technological advances in printing have also led to several large and potentially catastrophic problems for the fine art reproduction industry. In the past, the previously used complex and costly lithographic processes made it difficult to produce forgeries and unaccounted-for signed reproductions. Today's new ink jet technology allows small imaging firms, photo labs, quick copy franchises and even the artists themselves to produce fine art reproductions. These reproductions may not meet professional quality standards. In addition, today's ease of reproduction can lead to a lack of accountability regarding the actual number produced and sold as a limited edition.

The nature of today's fine art reproduction processes allows inexpensive forgeries to easily be produced and enter the art market. Forgeries and over-releasing of limited edition reproductions are negatively affecting the fine art reproduction market. The fine art reproduction industry seems content to bury it's head in the sand and hope that the fine art buyer isn't sophisticated enough to be aware of the large variations in quality of fine art reproductions and the increasing number of forgeries entering the market. A new standard for authentication and accountability of fine art limited editions needs to be developed, or the bottom may fall out of the fine art reproduction market through loss of consumer confidence.

### SUMMARY OF THE INVENTION

The present invention incorporates FAAS (Fine Art Authentication System) to authenticate fine art limited editions that are certified to be originals from an accounted-for limited edition. The authentication and registration process is unique to the fine art marketplace. Each reproduction has a non-reproducible RFID (Radio Frequency Identification Device) tag attached to the back of the canvas or paper, using a specially developed inert compound that will not react with the canvas or inks. The bonding is secure, acid-free and will not hurt or degrade the image. The embedded RFID tag is covered with a Lexan disk identifying the art as an authentic original reproduction.

The RFID contains an electronic digitally encrypted serial number that can be read by an inexpensive RFID scanner at participating galleries. This number is unique to the artist, the image and the edition number and cannot be reproduced. The device cannot be removed without destroying artwork and rendering the RFID tag inoperative. The electronically encrypted data may include the serial number, date of purchase, name of artist and number of reprints in the limited edition. The process allows certification that the artwork is authentic and that it is a specific number from the limited edition. Each RFID tag may be provided with encrypted data that is unique to the RFID tag and to the vendor and can be read only by properly programmed scanners.

Through the FAAS process and by working closely with the artist, the invention provides a guarantee to the buyer that only a specific number of reproductions were produced, signed by the artist, authenticated and registered. The unique FAAS process provides checks-and-balances between the artist, the reproduction house and the art buyer never before available. Not only is the original's date of production, place of production and quantity in the limited edition guaranteed, but the invention also permits a sales tracking service. At the seller and buyer's discretion, the invention permits updating the artist's proprietary production records with a tracking of when the artwork was originally sold, when it was resold and who presently owns the numbered artwork. A central service can also be contacted in the event of a theft to notify authorities and to document in corresponding records the edition number that was stolen.

The present process brings new sales potential to the fine art market. A new level of authentic reproduction becomes available to the artist and art buyer. The inventive authentication service is extremely inexpensive for the artist and adds new value to an artist's work. The inventive process brings new standards to the fine art market and could protect the market from the effects of the unprofessionally produced and forged fine art reproductions entering the market.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is an illustration of a first embodiment of the invention shown installed on the back of a framed work of art;

FIG. 2 is a front plan view of the first embodiment;

FIG. 3 is a side view of the first embodiment;

FIG. 4 is a back view of the first embodiment showing a contained RFID tag in phantom;

FIG. 5 is a side cross-sectional view of a second embodiment of the invention;

FIG. 6 is a layout illustration of the RFID tag of the second embodiment; and

FIGS. 7 and 8 provide bottom and cross-sectional side views, respectively, of a third embodiment RFID tag assembly.

### DETAILED DESCRIPTION OF PREFERRED EMBODIMENTS

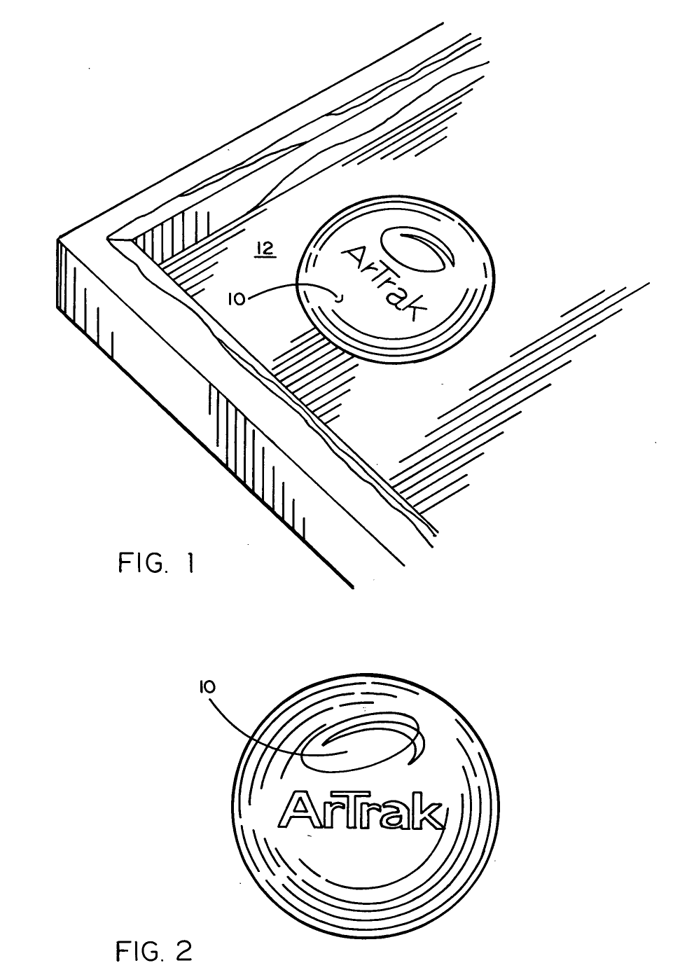

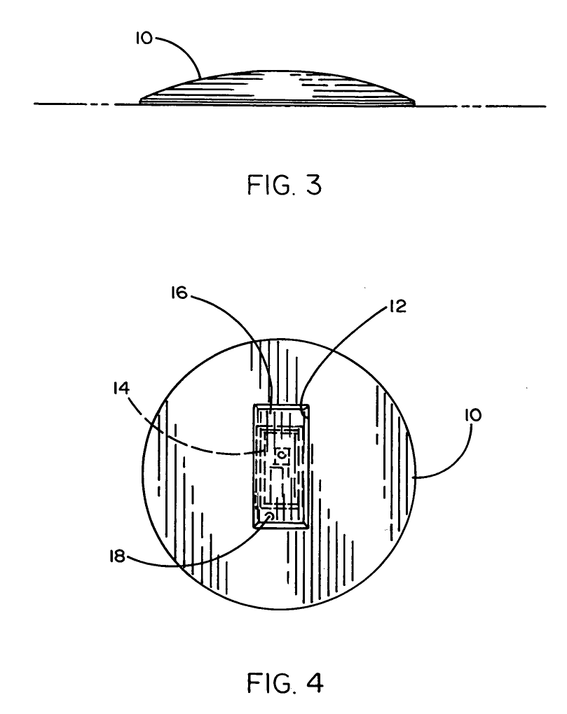

Referring to the accompanying figures, and particularly FIGS. 1 through 4, it will be seen that an authentication device 10 according to a first embodiment of the present invention, is affixed to the back surface of a work of art 12. The surface of the device 10 that is adhered to the art work includes a protective housing 15 that has a recess 16 in which there is positioned an RFID tag 14 which is secured therein by a bonding material 18. This bonding material also secures the device 10 to the art work's surface 12. The bonding is secure, acid-free and will not damage or degrade the art work image. However, any attempt to remove the device 10 will damage or destroy the art work. The bonding material is preferably an acid-free bond strength adhesive. The housing may be made of ABS or PVC which will not interfere with the RFID tag.

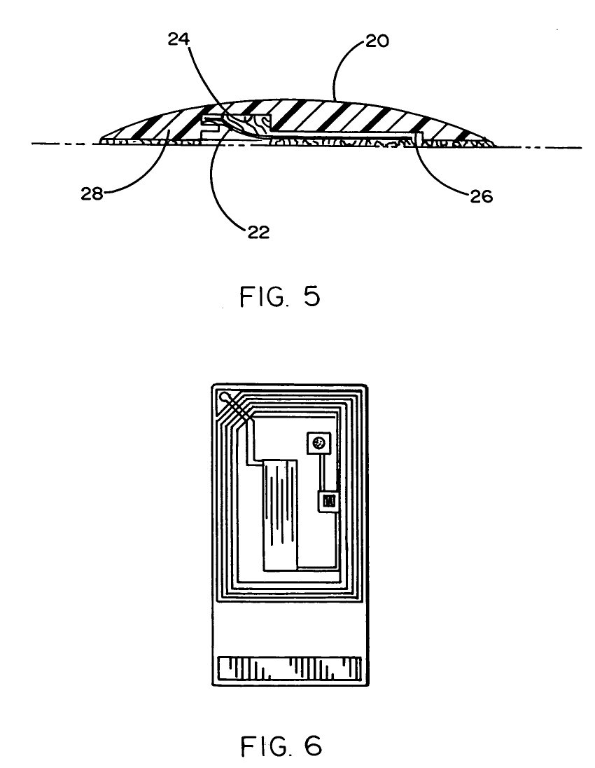

FIGS. 5 and 6 illustrate a second embodiment of the present invention. More specifically, an authentication device 20 comprises a flexible film-based PCB RFID tag 22 seen in FIG. 6. One end of the PCB RFID tag 22 is bonded into a deep recess 24 in the adhering surface of a protective housing 25 of the device 20. The remainder of PCB RFID tag 22 rests unbonded within shallow recess 26, but is bonded to the back surface of artwork 12 along with the perimeter 28 of the device 20. This configuration of the second embodiment assures that any attempt to remove the device will not only damage the surface of the art work, but will also damage the RFID tag to assure that it cannot be read or re-used.

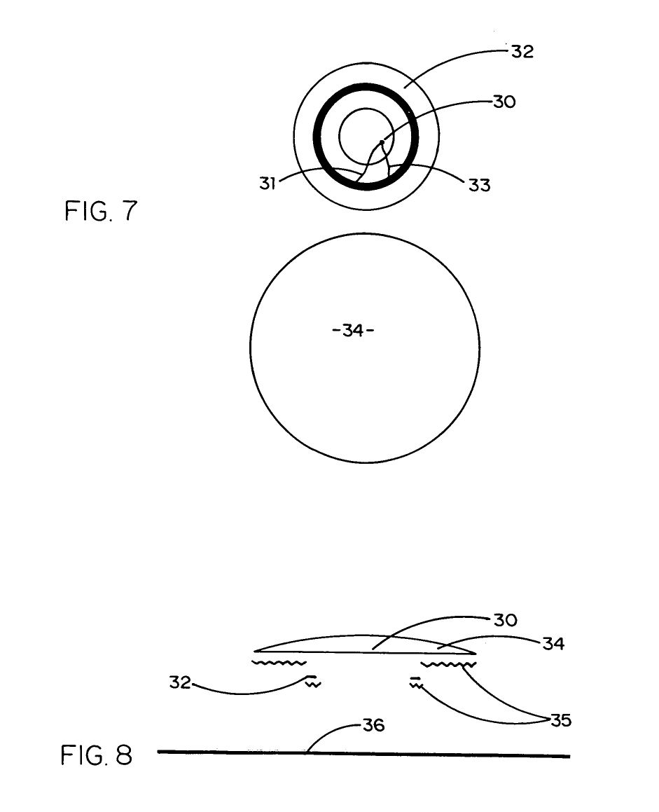

A third embodiment of the invention is illustrated in FIGS. 7 and 8. FIG. 7 illustrates still another RFID configuration comprising an RFID chip 30 attached by a pair of thin wires 31 and 33 to antenna 32, the latter comprising numerous planar circular turns of bare wire. As seen in FIG. 8, the RFID chip 30 is bonded into the housing 34 while the antenna 32 is glued to the artwork 36, but not to the housing 34 using glue 35. The perimeter of housing 34 is also glued to the artwork. In the event that the housing 34 is removed from the artwork, the antenna 32 which remains bonded to the artwork, will be pulled away from RFID chip 30 thereby breaking thin wires 31 and 33 and rendering the RFID tag inoperative.

The RFID tags used in the present invention may be interrogated by appropriately programmed known off-the-shelf RFID tag scanners commonly available from RFID tag manufacturers such as Texas Instruments and therefore need not be described herein in detail.

Having thus disclosed preferred embodiments of the invention, it will now be apparent that various modifications may be made thereto without deviating from the underlying concept of the invention or from its salient features. Accordingly, the scope hereof shall be limited only by the appended claims and their equivalents.

I claim:

1. A method for providing authentication of multiple authorized reproductions of a work of art, the method comprising the steps of:
a) providing an RFID tag for each of said reproductions;
b) programming each said RFID tag with information relating to each reproduction of said work of art including the total number of authorized reproductions and the specific number assigned to each said reproduction;
c) installing each said RFID tag in a corresponding protective housing; and
d) bonding each said housing to a corresponding reproduction in a manner which does not obscure the art and which would result in damage to the reproduction if removed therefrom.

2. The method recited in claim 1 wherein step c) includes the step of providing a recess in said housing for receiving said RFID tag.

3. The method recited in claim 1 wherein said housing is made of a non-conductive material which will not interfere with the transmission of electromagnetic energy to and from said RFID tag.

4. The method recited in claim 1 wherein said RFIG tag is configured as a flexible film-based printed circuit.

5. The method recited in claim 4 wherein in step d) a first part of said RFID tag printed circuit is bonded into said housing and a second part of said RFID tag printed circuit is bonded to said reproduction.

6. The method recited in claim 5 wherein said first part of said RFID tag printed circuit is not bonded to said reproduction.

7. The method recited in claim 5 wherein said second part of said RFID tag printed circuit is not bonded to said housing.

8. The method recited in claim 1 wherein each said RFID tag has a unique number associated with it.

9. The method recited in claim 1 wherein the information programmed into each RFID tag is encrypted so that it can be deciphered only by a scanner appropriately programmed to decrypt the information.

10. An apparatus used for authenticating a work of art, the apparatus comprising:
an RFID tag that is programmed to contain information relevant to the work of art and which uniquely identifies the work of art;
a housing for receiving the RFID tag in a manner that prevents access to the RFID tag after attachment of the housing to the work of art; and
a bonding material for affixing the housing and the RFID tag to the work of art in a manner which will not obscure the work of art, but which will damage the work of art if the housing is removed therefrom.

11. The apparatus recited in claim 10 wherein said RFID tag is configured and contained in said housing in a manner which will destroy the RFID tag if the housing is removed from the work of art.

12. The apparatus recited in claim 11 wherein said RFID tag comprises a flexible film-based printed circuit having a first part bonded to said housing and a second part for bonding to said work of art.

13. The apparatus recited in claim 11 wherein said RFID tag comprises an RFID chip attached to an antenna and wherein one of said chip and antenna is bonded to said housing and the other of said chip and antenna is for bonding to said work of art.

14. The apparatus recited in claim 10 wherein said information is encoded so that it can be understood only by scanners having a corresponding decoding program.
